(19) United States
(12) Patent Application Publication
(10) Pub. No.: US 2008/0221271 A1
(43) Pub. Date: Sep. 11, 2008

(54) TERPOLYMER METHACRYLATE DISPERSANT

(76) Inventors: Akhilesh Duggal, Midlothian, VA (US); Theresa L. Slayton, Richmond, VA (US)

Correspondence Address: LUEDEKA, NEELY & GRAHAM, P.C., P O BOX 1871, KNOXVILLE, TN, 37901, US

(21) Appl. No.: 11/682,087

(22) Filed: Mar. 5, 2007

(51) Int. Cl. C08F 2/36

(52) U.S. Cl. 525/191

(57) ABSTRACT

A methacrylate terpolymer, methods for making the terpolymer, and lubricant compositions containing the terpolymer. The terpolymer is derived from (a) a C₄-alkylmethacrylate monomeric unit; (b) a C₁₀₋₁₅-alkylmethacrylate monomeric unit; and (c) a di-lower-alkylaminoalkyl methacrylate monomeric unit. Component (a) is in the terpolymer in an amount ranging from about 15 up to less than about 30 percent by weight of the terpolymer. Component (b) is in the terpolymer in an amount ranging from more than about 70 up to about 80 percent by weight of the terpolymer. Component (c) is in the terpolymer in an amount ranging from about 2 to less than about 10 percent by weight of the terpolymer.

### TECHNICAL FIELD

The disclosure relates to novel, oil-soluble, dispersant methacrylate terpolymers having excellent dispersing properties.

### BACKGROUND AND SUMMARY

Additives for improving properties of petroleum products for relatively low temperature and/or high pressure applications such as viscosity index improving additives and pour point depressants are known. Viscosity index improving and pour point additives reduce the influence of temperature changes on fluid viscosity and fluid flow properties. Of the viscosity index improving additives, acrylic acid ester copolymers are particularly suitable for such applications. However, petroleum products containing the acrylic acid ester copolymers have a tendency to form acids in the presence of ambient moisture during use, particularly in high pressure (above 20 MPascals pressure) applications. Accordingly, there exists a need for petroleum additives that are particularly suited for improving dispersancy and fluid flow characteristics.

With regard to the above and other objects and advantages, in one embodiment, the disclosure provides methacrylate terpolymer, methods for making the terpolymer, and petroleum products containing the terpolymer. The terpolymer is derived from (a) a C₄-alkylmethacrylate monomeric unit; (b) a C₁₀₋₁₅-alkylmethacrylate monomeric unit; and (c) a di-lower-alkylaminoalkyl methacrylate monomeric unit, wherein the di-lower-alkylaminoalkyl methacrylate is selected from N,N-dimethylaminoethyl methacrylate, N,N-diethylaminoethyl methacrylate, t-butylaminoethyl methacrylate, and N,N-dimethylaminopropyl methacrylate. Component (a) is present in the terpolymer in an amount ranging from about 15 up to less than about 30 percent by weight of the terpolymer. Component (b) is present in the terpolymer in an amount ranging from more than about 70 up to about 80 percent by weight of the terpolymer. Component (c) is present in the terpolymer in an amount ranging from about 2 to less than about 10 percent by weight of the terpolymer.

In another embodiment, there is provided a method for making a terpolymer derived from monomeric ester components. The method includes providing a reaction mixture in a reaction vessel. The reaction mixture includes (1) from about 5 to about 10 percent by weight C₄-alkylmethacrylate monomer; (2) from about 25 to about 35 percent by weight C₁₀₋₁₅-alkylmethacrylate monomer; (3) from about 0.5 to about 5 percent by weight di-lower-alkylaminoalkyl methacrylate monomer, wherein the di-lower-alkylaminoalkyl methacrylate is selected from N,N-dimethylaminoethyl methacrylate, N,N-diethylaminoethyl methacrylate, t-butylaminoethyl methacrylate, and N,N-dimethylaminopropyl methacrylate; (4) a chain transfer agent; (5) a free-radical polymerization initiator; and (6) a low sulfur polymerization solvent. Prior to initiating the reaction, the reaction vessel and reaction mixture are purged with nitrogen. The reaction mixture is then reacted under conditions sufficient to provide a terpolymer reaction product containing from about 15 up to less than about 30 percent by weight of monomeric units derived from (1), from more than about 70 up to about 80 percent by weight of monomeric units derived from (2), and from about 2 to less than about 10 percent by weight of monomeric units derived from (3).

An advantage of the embodiments disclosed herein is that fluids, containing the methacrylate terpolymer may exhibit improved low temperature thickening and shear stability, and improved dispersancy. For example, the terpolymer may be effective to decrease organic deposit formation in aqueous and organic systems and process equipment, as well as providing improved dispersancy for petroleum refinery pipelines. Other advantages of the methacrylate terpolymer may include an increase in shear stability of lubricant compositions containing the terpolymer. Accordingly, the terpolymer may provide effective dispersant and viscosity maintaining properties for engine lubricants, transmission fluid, gear oils, and the like.

### DETAILED DESCRIPTION OF EMBODIMENTS OF THE DISCLOSURE

As used herein, the term “terpolymer” means a polymer having at least three different repeating unit and includes, for example, oligomers, copolymers, and tetrapolymers.

As used herein, the term “monomer” means a chemical compound or composition having an olefinic double bond present in the compound or composition. The term “monomeric unit” means a polymeric unit derived from a monomer.

As used herein, the term “hydrocarbyl substituent” or “hydrocarbyl group” is used in its ordinary sense, which is well-known to those skilled in the art. Specifically, it refers to a group having a carbon atom directly attached to the remainder of a molecule and having a predominantly hydrocarbon character. Examples of hydrocarbyl groups include:
(1) hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form an alicyclic radical);
(2) substituted hydrocarbon substituents, that is, substituents containing non-hydrocarbon groups which, in the context of the description herein, do not alter the predominantly hydrocarbon substituent (e.g., halo (especially chloro and fluoro), hydroxy, alkoxy, mercapto, alkylmercapto, nitro, nitroso, and sulfoxy);
(3) hetero-substituents, that is, substituents which, while having a predominantly hydrocarbon character, in the context of this description, contain other than carbon in a ring or chain otherwise composed of carbon atoms. Hetero-atoms include sulfur, oxygen, nitrogen, and encompass substituents such as pyridyl, furyl, thienyl and imidazolyl. In general, no more than two, preferably no more than one, non-hydrocarbon substituent will be present for every ten carbon atoms in the hydrocarbyl group; typically, there will be one non-hydrocarbon substituent in the hydrocarbyl group.

The acrylic acid ester copolymers described herein include random copolymers containing at least three repeating units. The first monomeric repeating unit has the structural formula:

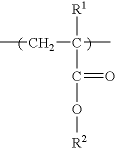

wherein each R¹ is independently selected from H or a methyl group and R² is a C₄ branched or straight chain alkyl group, for example, n-butyl, isobutyl, t-butyl and mixtures thereof. The copolymer may contain from about 15 up to less than about 30 percent by weight of the first repeating unit.

The second monomeric repeating unit has the structural formula:

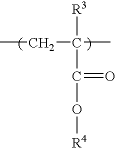

wherein each R³ is independently selected from H or a methyl group and each R⁴ is independently selected from a C₁₀ to a C₁₅ branched or straight chain alkyl group, for example, decyl, isodecyl, undecyl, lauryl, myristyl, dodecyl, pentadecyl, and mixtures thereof. The copolymer may contain more than about 70 up to about 80 percent by weight of the second repeating unit.

The third monomeric repeating unit has the structural formula:

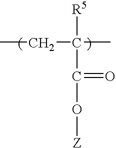

wherein each R⁵ is independently selected from H or a methyl group and each Z is independently selected from an alkyl aminoalkyl group and mixtures thereof wherein Z has the structural formula:

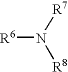

wherein R⁶ is a lower alkyl group containing from about 1 to about 4 carbon atoms, and each of R⁷ and R⁸ are independently selected from H and a C₁ to C₄ alkyl group. Examples of the third monomeric repeating unit include, but are not limited to, N,N-dimethylaminoethyl methacrylate, N,N-diethylaminoethyl methacrylate, t-butylaminoethyl methacrylate, and N,N-dimethylaminopropyl methacrylate. The copolymer may contain from about 2 to less than about 10 percent by weight of the third repeating unit.

As set forth above, the acrylic acid ester copolymer containing the first, second, and third repeating units is substantially devoid of unreacted monomer components providing the first, second, and third monomeric repeating units. By “substantially devoid” it is meant that the reaction product contains no more than about 1 percent by weight of unreacted monomers, and typically less than about 1 percent by weight of unreacted monomers. A weight average molecular weight (M_{w}) for the copolymer may range from about 100,0000 to about 150,000 daltons as determined by gel permeation chromatography and a number average molecular weight (Mₙ) for the copolymer may range from about 50,000 to about 100,000 daltons as determined by gel permeation chromatography.

The copolymers described herein may be made by free radical initiated polymerization of alkyl methacrylate monomers, wherein the term “alkyl methacrylate” is used to refer to alkyl acrylate monomers, alkyl methacrylate monomers and mixtures thereof. Similarly, the terminology “methacrylic acid” is used herein to refer to acrylic acid, methacrylic acid and mixtures thereof. Commercially available alkyl methacrylate monomers may be, and typically are, mixtures of esters.

In a process for making the acrylic acid ester copolymers described herein, a reaction vessel devoid of oxygen is charged with a mixture of the three monomeric units described above sufficient to provide a copolymer with the desired content of the first, second, and third monomeric units. An effective amount of polymerization initiator, chain transfer agent, and diluent oil are also charged to the reaction vessel.

For example, a reaction vessel may be charged with from about 5 to about 10 parts by weight of the first monomeric unit, from about 25 to about 35 parts by weight second monomeric unit, from about 0.5 to about 5 parts by weight of the third monomeric unit, from about 0.01 to about 1.0 parts by weight polymerization initiator, from about 0.05 to about 1.0 parts by weight alkyl mercaptan chain transfer agent, and from about 50 to about 70 parts by weight diluent oil to provide a reaction mixture.

Suitable polymerization initiators include initiators which disassociate upon heating to yield a free radical, e.g., peroxide compounds such as benzoyl peroxide, t-butyl perbenzoate, t-butyl peroctoate and cumene hydroperoxide; and azo compounds such as azoisobutyronitrile and 2,2′-azobis(2-methylbutanenitrile). The reaction mixture typically includes from about 0.02 wt % to about 3.0 wt % initiator relative to the total monomeric units mixture.

Suitable chain transfer agents include those conventional in the art, such as alkyl mercaptans, e.g., dodecyl mercaptan and ethyl mercaptan. The selection of the amount of chain transfer agent to be used is based on the desired molecular weight of the polymer being synthesized as well as the desired level of shear stability for the polymer, i.e., if a more shear stable polymer is desired, more chain transfer agent may be added to the reaction mixture. Preferably, the chain transfer agent is added to the reaction mixture in an amount of 0.1 to 3.0 weight percent chain transfer agent relative to total monomeric units mixture.

The diluent may be an inert hydrocarbyl fluid and is preferably a hydrocarbon lubricating oil selected from a Group II base oil. Suitable Group II base oils typically have a sulfur content of less than about 300 ppm. The reaction mixture preferably includes from about 100 to about 250 parts by weight (pbw) Group II base oil per 100 pbw total monomeric units in the mixture. As used herein, “total monomeric units” means the combined amount of all monomers in the reaction mixture.

By way of example and without limitation, the reaction mixture is charged to a reaction vessel that is equipped with a stirrer, a thermometer and a reflux condenser and heated with stirring under a nitrogen atmosphere to a temperature ranging from about 50° C. to about 125° C., for a period of about 0.5 hours to about 8 hours to carry out the copolymerization reaction.

In accordance with the foregoing procedure, a copolymer product may be made wherein conversion of the monomers is about 90% or more and the amount of unreacted monomers in the reaction product is less than about 1 percent by weight of the total weight of the reaction product. In the alternative, a copolymer reaction product may be purified by conventional techniques to remove substantially all unreacted monomers. For example, a scavenger may be used to reduce the amount of unreacted monomers in the copolymer reaction product, generally as described in U.S. Pat. No. 4,737,577 to Brown.

The following non-limiting example is provided to illustrate a reaction mixture that may provide the methacrylate terpolymers provided herein.

TABLE 1

| Raw Material/Reagent | Weight Percent |
|---|---|
| Butyl methacrylate | 7.96 |
| Lauryl methacrylate | 29.86 |
| Dimethylaminoethylmethacrylate | 1.99 |
| Azoisobutyronitrile | 0.10 |
| n-dodecyl mercaptan | 0.09 |
| Group II hydrocracked process oil | 60.00 |
| Total | 100 |

TABLE 2

| Reaction Product | Weight Percent |
|---|---|
| Butyl methacrylate, lauryl methacrylate, | 40 |
| dimethylaminoethylmethacrylate | |
| Group II hydrocracked process oil | 60.00 |
| Total | 100 |

TABLE 3

| Terpolymer composition | Weight Percent |
|---|---|
| Butyl methacrylate | 20 |
| Lauryl methacrylate | 75 |
| Dimethylaminoethylmethacrylate | 5 |
| Total | 100 |

The amount of unreacted monomer in the terpolymer product may be determined by proton (1H) NMR analysis. According to this method a sample of the terpolymer product is weighed and diluted with deutero-chloroform (d-chloroform) to form a solution of the product. To this solution, a known amount of trichloroethylene (TCE) is added as an internal standard. The 1H NMR spectrum of the sample solution is acquired, processed and plotted. Integration of the TCE and unreacted monomers is completed and the integrations are used to calculate the unreacted weight percent of the monomers in the terpolymer product. The molecular weight (MW) of the initial monomer mix is calculated and used in the weight percent calculation. Individual monomers are not distinguished by this method and are assumed to deplete at the same rate during the polymerization reaction. The method may be used to determine the amount of unreacted monomer containing butyl, lauryl, and dimethylaminoethyl methacrylates.

Analysis Procedure

1. Weigh approximately 5 grams to the nearest 0.1 mg of terpolymer product sample into a 20 ml scintillation vial and record the weight.

2. Add the appropriate amount of d-chloroform to the product sample vial and record the weight to the nearest 0.1 mg of d-chloroform added. Cap the vial with a septum top cap with liner. Mix the product sample into the d-chloroform until completely mixed.

3. Draw approximately 100 microliters of TCE into the syringe. Invert the syringe to remove trapped air from the syringe and barrel. Weigh the syringe with the TCE to the nearest 0.1 mg and record the weight.

4. Release gas pressure from the vial. Insert the syringe through the septum and deliver approximately 30 microliters or the appropriate amount of standard to the product sample solution. Retighten the cap on the sample vial and mix the resulting solution. Reweigh the syringe and remaining TCE to the nearest 0.1 mg and record the weight.

5. Transfer an appropriate amount of the sample of product sample/TCE solution to an NMR tube for proton (1H) NMR analysis.

Based on measured T1 relaxation times, use a recycling delay sufficient for complete relaxation of the Proton (1H) NMR signals for analysis. Typical NMR parameters are a 35-40 second recycle delay and 64 scans (NS). Analysis of the proton NMR requires that the TCE, the chemical shifts of the monomers be integrated as follows:

| Shift ID | (ppm) | Integral range (ppm) |
|---|---|---|
| TCE | 6.435 | 6.52 to 6.32 |
| Beta-proton | 6.024 | 6.10 to 5.95 |
| Alpha-proton | 5.45 | 5.53 to 5.40 |

The unreacted alkyl methacrylate monomers have two chemical shifts for the alpha and beta protons of the vinylidene olefin. An average the two chemical shift areas is completed to improve the accuracy of the analysis. The average peak areas are used in the calculation below.

A. (TCE integral area/TCE# protons(1))/(TCE added wt./TCE MW)=(X-Area/H-Mole)

B. (unreacted monomer integral area/terpolymer Monomer proton (1))/(X-Area/H-Mole)=Y-moles

C. ((terpolymer average MW)*(Y-moles))/(product sample weight)*100=(Weight % monomer content)

The foregoing method is based on the assumption that all of the monomers are depleted at the same rate. The average monomer molecular weight is calculated and used for the sample MW in the above calculations. The results for the unreacted alkyl monomer content are calculated to produce a total unreacted monomer concentration.

A lubricant composition may be made with the terpolymer product by combining the terpolymer product with a base oil, e.g., a paraffinic solvent neutral oil, in a conventional manner to provide a lubricant composition having the desired viscometric properties. In the alternative, a concentrate containing the terpolymer product may be made and added to a base oil. Typically, a lubricant composition may contain from about 1 part by weight to about 20 parts by weight of the terpolymer product.

Lubricating oil compositions may include other additives in addition to the terpolymer component described above, e.g., oxidation inhibitors, corrosion inhibitors, friction modifiers, antiwear agents, mild extreme pressure agents, detergents, dispersants, antifoamants, additional viscosity index improvers, and pour point depressants. Such additive components are included in the lubricating oil compositions in amounts effective to provide the desired properties.

### Antiwear Agents

The antiwear agents used in combination with the terpolymers described herein may be metal salts of containing sulfur and phosphorus atoms, for example, zinc dialkyldithiophosphate (ZDDP) and/or ashless antiwear agents such as glycerol monooleate. The antiwear additive packages may contain from about 40 to about 80 percent by weight antiwear agent, from about 15 to about 25 percent by weight phenolic antioxidant, from about 1 to about 10 percent by weight amine antioxidant, from about 1 to about 10 percent by weight overbased alkaline-earth metal phenate, from about 1 to about 5 percent by weight neutral alkaline-earth metal sulfonate, from about 1 to about 5 percent by weight rust inhibitor/friction modifier, from about 0.5 to about 5 percent by weight demulsifier, and process oil.

### Base Oils

Base oils suitable for use in formulating the compositions, additives and concentrates described herein may be selected from any of the synthetic or natural oils or mixtures thereof. The synthetic base oils include alkyl esters of dicarboxylic acids, polyglycols and alcohols, poly-alpha-olefins, including polybutenes, alkyl benzenes, organic esters of phosphoric acids, polysilicone oils, and alkylene oxide polymers, interpolymers, copolymers and derivatives thereof where the terminal hydroxyl groups have been modified by esterification, etherification, and the like. The synthetic oils may also include the gas to liquid synthetic oils.

Natural base oils include animal oils and vegetable oils (e.g., castor oil, lard oil), liquid petroleum oils and hydrorefined, solvent-treated or acid-treated mineral lubricating oils of the paraffinic, naphthenic and mixed paraffinic-naphthenic types. Oils of lubricating viscosity derived from coal or shale are also useful base oils. In general, both the natural and synthetic base oils may each have a kinematic viscosity ranging from about 1 to about 40 cSt at 100° C., although typical applications may require the oil to have a viscosity ranging from about 2 to about 20 cSt at 100° C.

Hence, the base oil used which may be used as described herein may be selected from any of the base oils in Groups I-V as specified in the American Petroleum Institute (API) Base Oil Interchangeability Guidelines. Such base oil groups are as follows:

| | Sulfur | | | Viscosity |
|---|---|---|---|---|
| Base Oil Group¹ | (wt %) | | Saturates (wt %) | Index |
| Group I | >0.03 | and/or | <90 | 80 to 120 |
| Group II | ≦0.03 | And | ≧90 | 80 to 120 |
| Group III | ≦0.03 | And | ≧90 | ≧120 |

| | |
|---|---|
| Group IV | all polyalphaolefins (PAOs) |
| Group V | all others not included in Groups I–IV |

¹Groups I–III are mineral oil base stocks.

Lubricating oil compositions containing an effective amount of the terpolymers described herein as a viscosity index improver and/or dispersant may be used in numerous applications including gear lubrication, automatic transmission fluids, continuously variable transmission fluids, manual transmission fluids, hydraulic fluids, crankcase applications and shock absorber fluids.

For other applications, oleaginous fluids may include other conventional components in addition to the terpolymer and/or metal antiwear agent. For example, automatic transmission fluids, gear oils, and crankcase fluids may contain one or more antioxidants, dispersants, detergents, corrosion inhibitors, antifoam agents, rust inhibitor, extreme pressure agents, and the like.

### Antioxidant Component

In some embodiments, antioxidant compounds may be included in the compositions. Antioxidants include phenolic antioxidants, aromatic amine antioxidants, sulfurized phenolic antioxidants, and organic phosphites, among others. Examples of phenolic antioxidants include 2,6-di-tert-butylphenol, liquid mixtures of tertiary butylated phenols, 2,6-di-tert-butyl-4-methylphenol, 4,4′-methylenebis(2,6-di-tert-butylphenol),2,2′-methylenebis(4-methyl-6-tert-butylphenol), mixed methylene-bridged polyalkyl phenols, and 4,4′-thiobis(2-methyl-6-tert-butylphenol). N,N′-di-sec-butyl-phenylenediamine, 4-isopropylaminodiphenylamine, phenyl-.alpha.-naphthyl amine, phenyl-.alpha.-naphthyl amine, and ring-alkylated diphenylamines. Examples include the sterically hindered tertiary butylated phenols, bisphenols and cinnamic acid derivatives and combinations thereof.

The amount of antioxidant component in petroleum compositions described herein is less than about 0.5 percent by weight of the total weight of lubricant composition. Typically, the antioxidant component may range from about 0.05 to about 0.25 weight percent based on the total weight of the composition.

### Ashless Dispersant Component

Dispersants contained in the petroleum and lubricating compositions described herein include, but are not limited to, an oil soluble polymeric hydrocarbon backbone having functional groups that are capable of associating with particles in the compositions to be dispersed. Typically, the dispersants comprise amine, alcohol, amide, or ester polar moieties attached to the polymer backbone often via a bridging group. Dispersants may be selected from Mannich dispersants as described in U.S. Pat. Nos. 3,697,574 and 3,736,357; ashless succcinimide dispersants as described in U.S. Pat. Nos. 4,234,435 and 4,636,322; amine dispersants as described in U.S. Pat. Nos. 3,219,666, 3,565,804, and 5,633,326; Koch dispersants as described in U.S. Pat. Nos. 5,936,041, 5,643,859, and 5,627,259, and polyalkylene succinimide dispersants as described in U.S. Pat. Nos. 5,851,965; 5,853,434; and 5,792,729. Dispersants may be boronated, phosphorylated, and/or glycolated as described in U.S. Pat. Nos. 4,455,243, 4,652,387, 5,171,466, and 5,235,067.

### Extreme Pressure Agent

Various types of sulfur-containing extreme pressure agents may be used in a lubricant composition used for gear oil applications. Examples of extreme pressure agents include dihydrocarbyl polysulfides; sulfurized olefins; sulfurized fatty acid esters of both natural and synthetic origins; trithiones; sulfurized thienyl derivatives; sulfurized terpenes; sulfurized oligomers of C₂-C₈ monoolefins; and sulfurized Diels-Alder adducts such as those disclosed in U.S. reissue Pat. Re 27,331. Specific examples include sulfurized polyisobutene, sulfurized isobutylene, sulfurized diisobutylene, sulfurized triisobutylene, dicyclohexyl polysulfide, diphenyl polysulfide, dibenzyl polysulfide, dinonyl polysulfide, and mixtures of di-tert-butyl polysulfide such as mixtures of di-tert-butyl trisulfide, di-tert-butyl tetrasulfide and di-tert-butyl pentasulfide, among others. Combinations of such categories of sulfur-containing extreme pressure agents can also be used, such as a combination of sulfurized isobutylene and di-tert-butyl trisulfide, a combination of sulfurized isobutylene and dinonyl trisulfide, a combination of sulfurized tall oil and dibenzyl polysulfide. The amount of extreme pressure agent in a gear oil additive package for a gear oil lubricant composition may range from about 75 to about 95 percent by weight of the total weight of the additive package. In terms of active sulfur content in the lubricant compositions, the lubricant composition may contain from about 1 wt. % to about 3 wt. % active sulfur.

### Corrosion Inhibitors

Copper corrosion inhibitors which may be used in lubricant compositions described herein may include thiazoles, triazoles and thiadiazoles. Examples include benzotriazole, tolyltriazole, octyltriazole, decyltriazole, dodecyltriazole, 2-mercaptobenzothiazole, 2,5-dimercapto-1,3,4-thiadiazole, 2-mercapto-5-hydrocarbyl-thio-1,3,4-thiadiazoles, 2-mercapto-5-hydrocarbyldithio-1,3,4-thiadiazoles, 2,5-bis(hydrocarbylthio)-1,3,4-thiadiazoles, and 2,5-bis-(hydrocarbyldithio)-1,3,4-thia-diazoles. The preferred compounds are the 1,3,4-thiadiazoles, especially the 2-hydrocarbyldithio-5-mercapto-1,3,4-dithiadiazoles and the 2,5-bis(hydrocarbyldithio)-1,3,4-thiadiazoles, a number of which are available as articles of commerce. Other suitable inhibitors of copper corrosion include ether amines; polyethoxylated compounds such as ethoxylated amines, ethoxylated phenols, and ethoxylated alcohols; imidazolines; and the like. See, for example, U.S. Pat. Nos. 3,663,561 and 4,097,387. Concentrations of up to about 5 wt. % in of the corrosion inhibitor component in an additive package for a lubricant composition are typical. Preferred copper corrosion inhibitors include ashless dialkyl thiadiazoles.

### Rust Inhibitors

Rust inhibitors selected from the group consisting of nonionic polyoxyalkylene polyols and esters thereof, polyoxyalkylene phenols, and anionic alkyl sulfonic acids, monocarboxylic acids, and polycarboxylic acids. Examples of suitable monocarboxylic acids are octanoic acid, decanoic acid and dodecanoic acid. Suitable polycarboxylic acids include dimer and trimer acids such as are produced from such acids as tall oil fatty acids, oleic acid, linoleic acid, or the like.

Another useful type of rust inhibitor which may be used is comprised of the alkenyl succinic acid and alkenyl succinic anhydride corrosion inhibitors such as, for example, tetrapropenylsuccinic acid, tetrapropenylsuccinic anhydride, tetradecenylsuccinic acid, tetradecenylsuccinic anhydride, hexadecenylsuccinic acid, hexadecenylsuccinic anhydride, and the like. Also useful are the half esters of alkenyl succinic acids having 8 to 24 carbon atoms in the alkenyl group with alcohols such as the polyglycols.

Still other suitable rust inhibitors include ether amines; acid phosphates; amines; polyethoxylated compounds such as ethoxylated amines, ethoxylated phenols, and ethoxylated alcohols; imidazolines; aminosuccinic acids or derivatives thereof, and the like. Materials of these types are available as articles of commerce. Mixtures of such rust inhibitors may be used. The amount of rust inhibitor in the gear oil additive package component may range from about 2 to about 8 weight percent based on the total weight of the lubricant or petroleum composition.

### Antifoam Agents

A foam inhibitor forms another component of the compositions described herein. Foam inhibitors may be selected from silicones, polyacrylates, surfactants, and the like. The amount of antifoam agent in the compositions described herein may range from about 0.5 to about 2.0 weight percent based on the total weight of the composition.

At numerous places throughout this specification, reference has been made to a number of U.S. patents. All such cited documents are expressly incorporated in full into this disclosure as if fully set forth herein.

In another embodiment, the terpolymer product described herein may be used to stabilize distillate fuels and lubricating oil compositions against sedimentation and deterioration during storage. The terpolymer product may be pre-mixed with other additives to improve the stabilizing performance of the terpolymer product. The terpolymer product may also be pre-mixed with other additives which improve other properties of fuel oils, for example, low temperature flow improvers, corrosion inhibitors, electrical conductivity improvers, cetane improvers, and dyes. An effective amount of terpolymer for the foregoing application may range from about 0.5 to about 500 mg/liter of fuel oil.

In yet another embodiment, the terpolymer product described herein may be used to disperse gums in hydrocarbon streams and the terpolymer product may be added to a hydrocarbon feed stream to inhibit deposits and fouling, such as in petroleum pipelines. An effective amount of terpolymer product that may be added to a hydrocarbon stream may range from about 0.0001 to about 0.5 percent by weight of the hydrocarbon stream.

The terpolymer product described herein may also be used to disperse high molecular weight hydrocarbon material in an olefin water quench tower. For example, in an ethylene manufacturing plant, cracked gases are quenched with water in a quench tower. During the quenching operation, steam and heavy hydrocarbons are condensed. The gases are also cooled prior to compression and to inhibit unwanted polymerization reactions. During the quenching operation, hydrocarbons may deposit and adhere to the trays, packing, interior of quench system coolers, other tower internals, and the oil/water separator causing fouling of these systems. In order to prevent fouling in such systems, an effective amount of the terpolymer product described herein may be added to the quench water tower. Depending on the nature of the stream being processed, an effective deposit inhibiting amount of the additive may range from about 0.5 to about 1,000 parts per million.

Other embodiments of the disclosure will be apparent to those skilled in the art from consideration of the specification and practice of the embodiments disclosed herein.

As used throughout the specification and claims, “a” and/or “an” may refer to one or more than one. Unless otherwise indicated, all numbers expressing quantities of ingredients, properties such as molecular weight, percent, ratio, reaction conditions, and so forth used in the specification and claims are to be understood as being modified in all instances by the term “about.” Accordingly, unless indicated to the contrary, the numerical parameters set forth in the specification and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosed embodiments are approximations, the numerical values set forth in the specific examples are reported as precisely as possible. Any numerical value, however, inherently contains certain errors necessarily resulting from the standard deviation found in their respective testing measurements. It is intended that the specification and examples be considered as exemplary only, with a true scope and spirit of the embodiments being indicated by the following claims.

The patentees do not intend to dedicate any disclosed embodiments to the public, and to the extent any disclosed modifications or alterations may not literally fall within the scope of the claims, they are considered to be part of the disclosed embodiments under the doctrine of equivalents.

What is claimed is:

1. A methacrylate terpolymer derived from monomeric units consisting essentially of:
(a) a C₄-alkylmethacrylate monomeric unit;
(b) a C₁₀₋₁₅-alkylmethacrylate monomeric unit; and
(c) a di-lower-alkylaminoalkyl methacrylate monomeric unit selected from the group consisting of N,N-dimethylaminoethyl methacrylate, N,N-diethylaminoethyl methacrylate, t-butylaminoethyl methacrylate, and N,N-dimethylaminopropyl methacrylate;
wherein component (a) comprises an amount ranging from about 15 up to less than about 30 percent by weight of the terpolymer, component (b) comprises an amount ranging from more than about 70 up to about 80 percent by weight of the terpolymer, and component (c) comprises an amount ranging from about 2 to less than about 10 percent by weight of the terpolymer.

2. The terpolymer of claim 1, wherein the C₄-alkylmethacrylate monomeric unit is selected from the group consisting of n-butyl-, isobutyl-, and t-butyl-methacylate.

3. The terpolymer of claim 1, wherein the a C₁₀₋₁₅-alkylmethacrylate monomeric unit comprises lauryl methacrylate

4. The terpolymer of claim 1, wherein the di-lower-alkylaminoalkyl methacrylate monomeric unit comprises dimethylaminoethylmethacrylate.

5. The terpolymer of claim 1, wherein the terpolymer has a weight average molecular weight (M_{w}) ranging from about 100,000 to about 150,000 Daltons.

6. The terpolymer of claim 1, wherein the terpolymer has a number average molecular weight (Mₙ) ranging from about 50,000 to about 100,000 Daltons.

7. The terpolymer of claim 1, wherein the terpolymer has a polydispersity ranging from about 1.5 to about 2.5.

8. The terpolymer of claim 1, wherein component (a) has the structural formula: 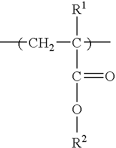
wherein each R¹ is independently selected from H or a methyl group and R² is a C₄ branched or straight chain alkyl group; component (b) has the structural formula: 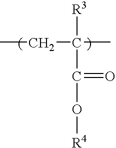
wherein each R³ is independently selected from H or a methyl group and each R⁴ is independently selected from a C₁₀ to a C₁₅ branched or straight chain alkyl group; and component (c) has the structural formula: 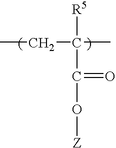
wherein each R⁵ is independently selected from H or a methyl group and each Z is independently selected from an alkyl aminoalkyl group and mixtures thereof wherein Z has the structural formula: 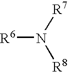
wherein R⁶ is a lower alkyl group containing from about 1 to about 4 carbon atoms, and each of R⁷ and R⁸ are independently selected from H and a C₁-C₄ alkyl group.

9. A dispersant composition comprising the terpolymer of claim 1.

10. The dispersant composition of claim 9, wherein the composition comprises less than about 1 percent by weight of unreacted monomeric units from (a), (b), (c).

11. A lubricant composition comprising the terpolymer of claim 1 in an amount sufficient to provide low temperature thickening and shear stability.

12. A motor vehicle crankcase comprising the lubricant composition of claim 11.

13. An automatic transmission for a motor vehicle comprising the lubricant composition of claim 11.

14. A gear oil composition comprising the terpolymer of claim 1 in an amount sufficient to provide low temperature thickening and shear stability.

15. A petroleum refinery product in a pipeline comprising a base oil and the terpolymer of claim 1.

16. A petroleum refinery product using an effective amount of the terpolymer of claim 1 to provide improved fluid properties for the refinery product.

17. A method for making a terpolymer derived from monomeric ester components, the method comprising the steps of:
(a) providing a reaction mixture in a reaction vessel, the reaction mixture comprising:
(1) from about 5 to about 10 percent by weight C₄-alkylmethacrylate monomer;
(2) from about 25 to about 35 percent by weight C₁₀₋₁₅-alkylmethacrylate monomer;
(3) from about 0.5 to about 5 percent by weight di-lower-alkylaminoalkyl methacrylate monomer selected from the group consisting of N,N-dimethylaminoethyl methacrylate, N,N-diethylaminoethyl methacrylate, t-butylaminoethyl methacrylate, and N,N-dimethylaminopropyl methacrylate;
(4) a chain transfer agent;
(5) a free-radical polymerization initiator; and
(6) a low sulfur polymerization solvent
(b) purging the reaction vessel and reaction mixture with nitrogen; and
(c) reacting the reaction mixture under conditions sufficient to provide a terpolymer reaction product containing from about 15 up to less than about 30 percent by weight of monomeric units derived from (1), from more than about 70 up to about 80 percent by weight of monomeric units derived from (2), and from about 2 to less than about 10 percent by weight of monomeric units derived from (3).

18. The method of claim 17, wherein the reaction product comprises from about 30 to about 50 percent by weight of the terpolymer reaction product and from about 50 to about 70 percent by weight of the solvent.

19. The method of claim 17, wherein the reaction product has a weight average molecular weight (M_{w}) ranging from about 100,000 to about 150,000 Daltons.

20. The method of claim 17, wherein the reaction product has a number average molecular weight (Mₙ) ranging from about 50,000 to about 100,000 Daltons.

21. The method of claim 17, wherein the reaction product has a polydispersity ranging from about 1.5 to about 2.5.

22. The method of claim 17, wherein the reaction product contains less than about one percent by weight unreacted monomeric units derived from (1), (2), and (3) based on the total weight of the terpolymer reaction product.

23. The method of claim 17, wherein the low sulfur polymerization solvent comprises a Group II paraffinic base oil having a sulfur content of less than about 300 ppm.
